(19) United States
(12) Patent Application Publication
(10) Pub. No.: US 2024/0168720 A1
(43) Pub. Date: May 23, 2024

(54) SYSTEMS AND METHODS FOR RANDOM NUMBER GENERATION

(71) Applicant: D-WAVE SYSTEMS INC., Burnaby (CA)

(72) Inventor: Mohammad H. Amin, Coquitlam (CA)

(21) Appl. No.: 18/113,735

(22) Filed: Feb. 24, 2023

Related U.S. Application Data
(60) Provisional application No. 63/313,451, filed on Feb. 24, 2022.

(51) Int. Cl. G06F 7/58; G06N 10/40; H04L 9/08

(52) U.S. Cl. CPC G06F 7/582; G06N 10/40; H04L 9/0852

(57) ABSTRACT

Systems and methods for random number generation are discussed. A first processor is in communication with a quantum processor, the quantum processor having an array of superconducting qubits. The first processor instructs the quantum processor to selectively communicatively couple the superconducting qubits to embed a quantum system having a highly entangled nontrivial ground state. The highly entangled nontrivial ground state comprising a uniform distribution of classical ground states. One or more distortions are introduced to the uniform distribution by one or more random variations based on an input value. The quantum processor evolves over the embedded quantum system. A set of one or more random numbers is received from the quantum processor.

### FIELD

This disclosure generally relates to random number generation, and in particular, to random number generation with a quantum processor.

### BACKGROUND

### Quantum Devices

Quantum devices are structures in which quantum mechanical effects are observable. Quantum devices include circuits in which current transport is dominated by quantum mechanical effects. Such devices include spintronics and superconducting circuits. Both spin and superconductivity are quantum mechanical phenomena. Quantum devices can be used for measurement instruments, in computing machinery, and the like.

### Quantum Computation

A quantum computer is a system that makes direct use of at least one quantum-mechanical phenomenon, such as, superposition, tunneling, and entanglement, to perform operations on data. The elements of a quantum computer are qubits. Quantum computers can provide speedup for certain classes of computational problems such as computational problems simulating quantum physics.

### Superconducting Qubits

Superconducting qubits are solid state qubits based on circuits of superconducting materials. Operation of superconducting qubits is based on the underlying principles of magnetic flux quantization, and Josephson tunneling. Superconducting effects can be present in different configurations and can give rise to different types of superconducting qubits including flux, phase, charge, and hybrid qubits. The different configurations can vary in the topology of the loops, the placement of the Josephson junctions, and the physical parameters of elements of the superconducting circuits, such as inductance, capacitance, and Josephson junction critical current.

### Quantum Processor

A quantum processor may take the form of a superconducting quantum processor. A superconducting quantum processor may include a number of superconducting qubits and associated local bias devices. A superconducting quantum processor may also include coupling devices (also known as couplers) that selectively provide communicative coupling between qubits.

In one implementation, the superconducting qubit includes a superconducting loop interrupted by a Josephson junction. The ratio of the inductance of the Josephson junction to the geometric inductance of the superconducting loop can be expressed as 2πLI_{c}/Φ₀ (where L is the geometric inductance, I_{c} is the critical current of the Josephson junction, and Φ₀ is the flux quantum). The inductance and the critical current can be selected, adjusted, or tuned, to increase the ratio of the inductance of the Josephson junction to the geometric inductance of the superconducting loop, and to cause the qubit to be operable as a bistable device. In some implementations, the ratio of the inductance of the Josephson junction to the geometric inductance of the superconducting loop of a qubit is approximately equal to three.

In one implementation, the superconducting coupler includes a superconducting loop interrupted by a Josephson junction. The inductance and the critical current can be selected, adjusted, or tuned, to decrease the ratio of the inductance of the Josephson junction to the geometric inductance of the superconducting loop, and to cause the coupler to be operable as a monostable device. In some implementations, the ratio of the inductance of the Josephson junction to the geometric inductance of the superconducting loop of a coupler is approximately equal to, or less than, one.

Further details and embodiments of exemplary quantum processors that may be used in conjunction with the present systems and devices are described in, for example, U.S. Pat. Nos. 7,533,068; 8,008,942; 8,195,596; 8,190,548; and 8,421,053.

The foregoing examples of the related art and limitations related thereto are intended to be illustrative and not exclusive. Other limitations of the related art will become apparent to those of skill in the art upon a reading of the specification and a study of the drawings.

### BRIEF SUMMARY

The generation of random numbers is important to many areas of endeavor, and is particularly useful in cryptography. In order to ensure secure data transmission, it is beneficial to provide random numbers such that third parties do not have access to the random numbers used. Improving the operation of processor-based devices to provide verifiably random numbers is generally desirable.

The systems and methods described herein may beneficially allow for the generation of truly random numbers that are certifiable. The described techniques may beneficially provide a balance between generating random numbers that are difficult to simulate classically and numbers that are still possible to simulate for certification. In order for this to be useful, the quantum processor may rapidly generate random numbers, and a small subset of those random numbers may be certified through classical simulation over a longer time scale. It is beneficial to use a quantum system such as a quantum spin liquid having highly complex correlations. See King et al., Qubit spin ice, arXiv:2007.10555v2 [quant-ph], 16 Jul. 2021, Chamon and Green, A superconducting circuit realization of combinatorial gauge symmetry, arXiv:2006.10060v1 [quant-ph], 17 Jun. 2020, and Zhou et al., Experimental Realization of Spin Liquids in a Programmable Quantum Device, arXiv:2009.07853v2 [cond-mat.str-el], 29 Sep. 2020, for further discussions of the features of quantum spin liquids. While an uncoupled quantum processor may generate random numbers, the resulting numbers would be unentangled and would be impossible to simulate, and therefore impossible to certify. The use of a system with highly complex correlations may beneficially allow for simulation. However, if a known and unmodified system is used for generation of random numbers, it may be possible to create a classical simulation of the complex correlations. Therefore, it is beneficial to modify the distribution for random number generation. Random distortions are added to make a distinct distribution that cannot be known by a third party and is not easily simulatable. By starting from a pseudo random but known input as a way to introduce random distortions to a quantum Hamiltonian, the system can beneficially move away from ideal randomness in a way that cannot be reproduced by a third party. It will be understood that the random numbers may, for example, be strings of digits of varying lengths as required by a given application. The random numbers may, in some implementations, be used as cryptographic keys to transmit data securely, or for other security applications.

A quantum processor must be sufficiently complex as to be difficult to simulate using a classical processor, but not impossible. For example, in some implementations, a quantum processor may have 5000 qubits and produce a random number every few seconds, while verifying and certifying a small subset of those random numbers, for example, a subset of 10 numbers, may take hours, a day, or longer. A pseudo random number may be generated and provided as input, allowing a user to generate random numbers from a distribution that cannot be known by a third party, but with a distortion that is known and has been controlled by the user and is therefore simulatable. Distortions applied are beneficially sufficiently large as to be distinguishable from other distributions, but not so large that the ground state becomes less complex. For example, if the distortions applied are bias values, if too many bias values are applied to qubits the system simply aligns with the bias values and becomes trivial. It is beneficial to apply only enough biases to qubits as to make the resulting distribution distinguishable from the original Hamiltonian's distribution.

According to an aspect, there is provided a method of generating random numbers, the method performed by a first processor in communication with a quantum processor, the quantum processor comprising a plurality of qubits, the method comprising defining a Hamiltonian having a highly entangled nontrivial ground state, the highly entangled nontrivial ground state comprising a uniform superposition of classical ground states, introducing one or more distortions to the Hamiltonian by one or more random variations, the one or more random variations selected based on an input value to provide a modified Hamiltonian, instructing the quantum processor to selectively communicatively couple the plurality of qubits to embed a quantum system defined by the modified Hamiltonian, causing the quantum processor to evolve over the embedded quantum system, and receiving a set of random numbers from the quantum processor.

According to other aspects, introducing one or more distortions to the Hamiltonian by one or more random variations may comprise introducing one or more of random coupling values, random biases on one or more qubits of the plurality of qubits, or randomly located defects in the quantum system, the method may further comprise providing a first input value by the first processor, wherein providing an input value comprises generating a pseudo random number as the input value, defining a Hamiltonian may comprise defining the Hamiltonian of a quantum spin liquid, instructing the quantum processor to selectively communicatively couple the plurality of qubits may comprise instructing the quantum processor to selectively communicatively couple the plurality of qubits in a 2D lattice, introducing one or more distortions to the Hamiltonian by one or more random variations may comprise introducing randomly located holes in the 2D lattice, the method may further comprise introducing one or more distortions to the Hamiltonian by one or more random variations based on a second input value to provide a second modified Hamiltonian, causing the quantum processor to evolve over the second modified Hamiltonian, and receiving a second set of random numbers from the quantum processor, the method may further comprise inputting a subset of numbers from the set of random numbers into a classical simulation of the quantum system, calculating a cross-entropy for the subset of numbers based on probabilities assigned to the subset of numbers from the classical simulation of the quantum system, comparing the cross-entropy to a threshold, and in response to the magnitude of the cross-entropy being greater than the threshold, returning a certification of the set of random numbers as authentic, inputting a subset of numbers from the set of random numbers into a classical simulation of the quantum system may comprise inputting the subset of numbers into a quantum Monte Carlo simulation, calculating a cross-entropy for the subset of numbers based on probabilities assigned to the subset of numbers from the classical simulation of the quantum system may comprise calculating a cross-entropy for the subset of numbers based on probabilities assigned to each of the numbers of the subset of numbers and a log likelihood of each number of the subset of numbers, and instructing the quantum processor to evolve over the embedded quantum system may comprise instructing the quantum processor to perform a quantum annealing evolution.

According to an aspect, there is provided a computing system for use in random number generation, the computing system comprising a first processor and a second processor, the first processor in communication with the second processor, the first processor comprising a quantum processor comprising a plurality of qubits selectively communicatively couplable by a plurality of couplers and at least one non-transitory processor-readable medium that stores at least one of processor executable instructions and data, the second processor communicatively coupled to the at least one non-transitory processor-readable medium, the second processor, in response to execution of the at least one of processor executable instructions and data: defines a Hamiltonian having a highly entangled nontrivial ground state, the highly entangled nontrivial ground state comprising a uniform superposition of classical ground states, defines one or more distortions to the Hamiltonian by one or more random variations, the one or more random variations selected based on the input value to provide a modified Hamiltonian, instructs the quantum processor to selectively communicatively couple the plurality of qubits to embed a quantum system defined by the modified Hamiltonian, causes the quantum processor to evolve over the embedded quantum system, and receive a set of random numbers from the quantum processor.

According to other aspects, the plurality of qubits may comprise a plurality of superconducting qubits, the input value may comprise a pseudorandom number provided by the second processor, the input value may define one or more random coupling values to one or more couplers of the plurality of couplers to introduce the one or more distortions, the computing system may further comprise one or more bias lines communicatively coupled to the plurality of qubits, and wherein the input value defines one or more random biases to the one or more bias lines to introduce the one or more distortions, the input value may define one or more randomly located defects to introduce the one or more distortions, the input value may comprise a pseudo random number generated by a classical processor, the embedded quantum system may comprise a quantum spin liquid and/or a 2D lattice, the input value may define randomly located holes in the 2D lattice to introduce the one or more distortions, the second processor may comprise a classical processor, at least one coupler of the plurality of couplers may comprise a parity coupler, a capacitive coupler, and/or an inductive coupler, and the quantum processor may comprise a quantum annealing processor.

In other aspects, the features described above may be combined together in any reasonable combination as will be recognized by those skilled in the art.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of a hybrid computing system including a digital computer coupled to an analog computer, in accordance with the present systems, devices, and methods.

FIG. 2 is a schematic diagram of a portion of an exemplary superconducting quantum processor.

FIG. 3 is a flow diagram of an example method of operation of a computing system to generate random numbers.

FIG. 4 is a flow diagram of an example method of operation of a computing system to verify and certify random numbers generated by a quantum processor.

FIG. 5 is a schematic diagram of a portion of an example quantum processor having part of an embedding of a quantum spin ice.

FIG. 6 is a schematic diagram of an example implementation of a circuit including a 4-qubit stabilizer.

FIG. 7 is a schematic diagram of an example implementation of a capacitive or charge coupler.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure, or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

### Exemplary Hybrid Computing System

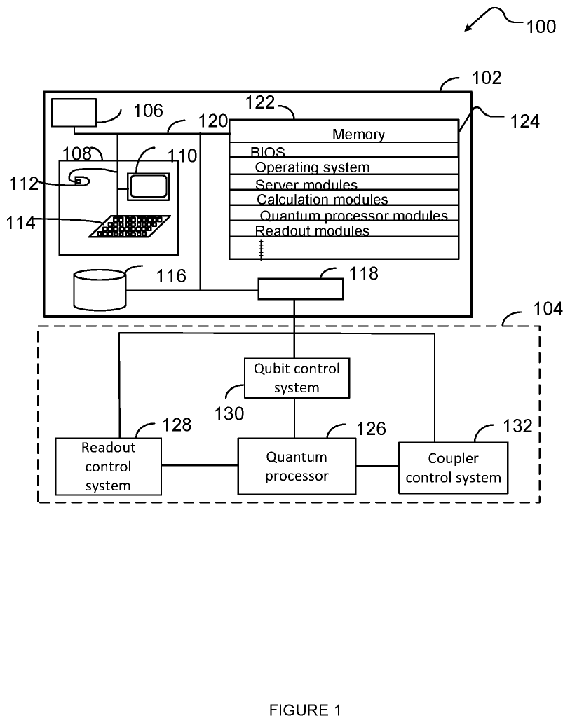

FIG. 1 illustrates a computing system 100 comprising a digital computer 102. The example digital computer 102 includes one or more digital processors 106 that may be used to perform classical digital processing tasks. Digital computer 102 may further include at least one system memory 122, and at least one system bus 120 that couples various system components, including system memory 122 to digital processor(s) 106. System memory 122 may store one or more sets of processor-executable instructions, which may be referred to as modules 124.

The digital processor(s) 106 may be any logic processing unit or circuitry (for example, integrated circuits), such as one or more central processing units (“CPUs”), graphics processing units (“GPUs”), digital signal processors (“DSPs”), application-specific integrated circuits (“ASICs”), programmable gate arrays (“FPGAs”), programmable logic controllers (“PLCs”), etc., and/or combinations of the same.

In some implementations, computing system 100 comprises an analog computer 104, which may include one or more quantum processors 126. Quantum processor 126 may include at least one superconducting integrated circuit. Digital computer 102 may communicate with analog computer 104 via, for instance, a controller 118. Certain computations may be performed by analog computer 104 at the instruction of digital computer 102, as described in greater detail herein.

Digital computer 102 may include a user input/output subsystem 108. In some implementations, the user input/output subsystem includes one or more user input/output components such as a display 110, mouse 112, and/or keyboard 114.

System bus 120 may employ any known bus structures or architectures, including a memory bus with a memory controller, a peripheral bus, and a local bus. System memory 122 may include non-volatile memory, such as read-only memory (“ROM”), static random-access memory (“SRAM”), Flash NAND; and volatile memory such as random-access memory (“RAM”) (not shown).

Digital computer 102 may also include other non-transitory computer- or processor-readable storage media or non-volatile memory 116. Non-volatile memory 116 may take a variety of forms, including: a hard disk drive for reading from and writing to a hard disk (for example, a magnetic disk), an optical disk drive for reading from and writing to removable optical disks, and/or a solid-state drive (SSD) for reading from and writing to solid state media (for example NAND-based Flash memory). Non-volatile memory 116 may communicate with digital processor(s) via system bus 120 and may include appropriate interfaces or controllers 118 coupled to system bus 120. Non-volatile memory 116 may serve as long-term storage for processor- or computer-readable instructions, data structures, or other data (sometimes called program modules or modules 124) for digital computer 102.

Although digital computer 102 has been described as employing hard disks, optical disks and/or solid-state storage media, those skilled in the relevant art will appreciate that other types of nontransitory and non-volatile computer-readable media may be employed. Those skilled in the relevant art will appreciate that some computer architectures employ nontransitory volatile memory and nontransitory non-volatile memory. For example, data in volatile memory may be cached to non-volatile memory or a solid-state disk that employs integrated circuits to provide non-volatile memory.

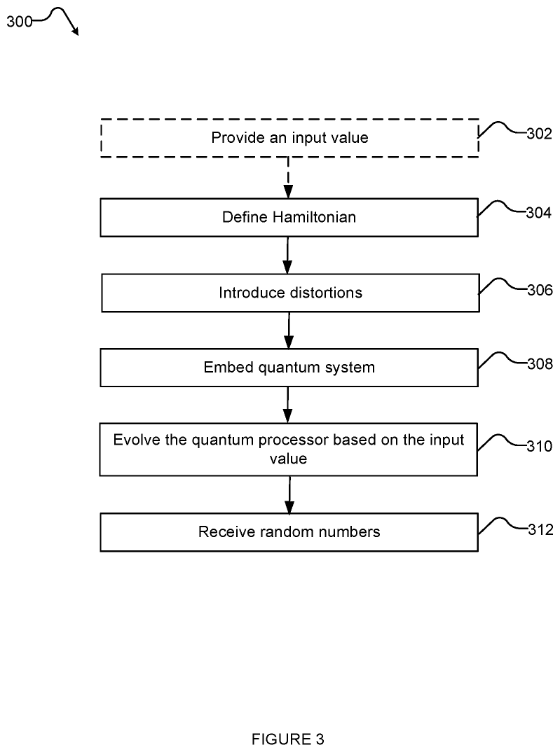

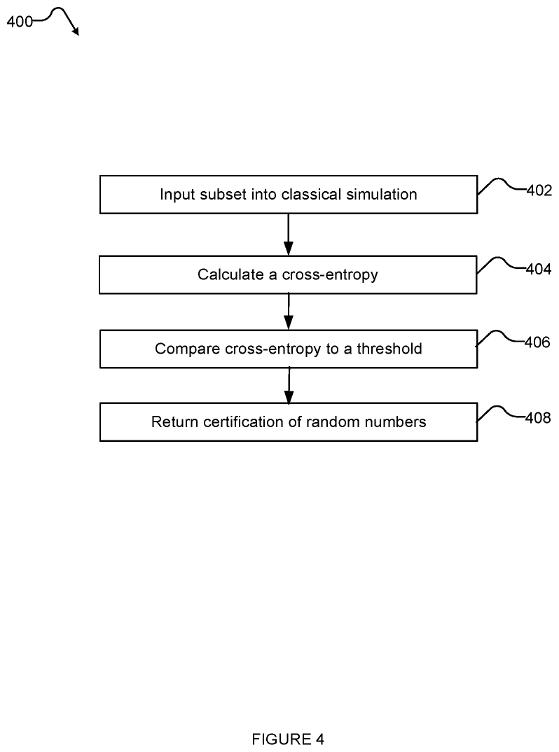

Various processor- or computer-readable and/or executable instructions, data structures, or other data may be stored in system memory 122. For example, system memory 122 may store instructions for communicating with remote clients and scheduling use of resources including resources on the digital computer 102 and analog computer 104. Also, for example, system memory 122 may store at least one of processor executable instructions or data that, when executed by at least one processor, causes the at least one processor to execute the various algorithms to execute instructions. In some implementations system memory 122 may store processor- or computer-readable calculation instructions and/or data to perform pre-processing, co-processing, and post-processing to analog computer 104. System memory 122 may store a set of analog computer interface instructions to interact with analog computer 104. For example, the system memory 122 may store processor- or computer-readable instructions, data structures, or other data which, when executed by a processor or computer causes the processor(s) or computer(s) to execute one, more or all of the acts of the methods described herein, such as methods 300 and 400 discussed below with reference to FIGS. 3 and 4.

Analog computer 104 may include at least one analog processor such as quantum processor 126. Analog computer 104 may be provided in an isolated environment, for example, in an isolated environment that shields the internal elements of the quantum computer from heat, magnetic field, and other external noise. The isolated environment may include a refrigerator, for instance a dilution refrigerator, operable to cryogenically cool the analog processor, for example to temperature below approximately 1 K.

Analog computer 104 may include programmable elements such as qubits, couplers, and other devices (also referred to herein as controllable devices). Qubits may be read out via readout system 128. Readout results may be sent to other computer- or processor-readable instructions of digital computer 102. Qubits may be controlled via a qubit control system 130. Qubit control system 130 may include on-chip Digital to Analog Converters (DACs) and analog lines that are operable to apply a bias to a target device. Couplers that couple qubits may be controlled via a coupler control system 132. Coupler control system 132 may include tuning elements such as on-chip DACs and analog lines. Qubit control system 130 and coupler control system 132 may be used to implement a quantum annealing schedule as described herein on analog processor 104. Programmable elements may be included in quantum processor 126 in the form of an integrated circuit. Qubits and couplers may be positioned in layers of the integrated circuit that comprise a first material. Other devices, such as readout control system 128, may be positioned in other layers of the integrated circuit that comprise a second material. In accordance with the present disclosure, a quantum processor, such as quantum processor 126, may be designed to perform quantum annealing and/or adiabatic quantum computation. Examples of quantum processors are described in U.S. Pat. No. 7,533,068.

### Exemplary Superconducting Quantum Processor

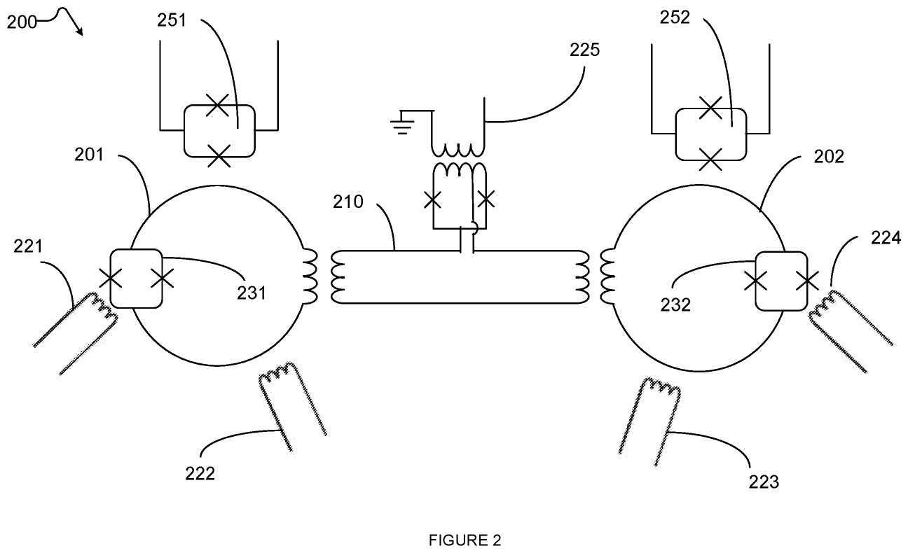

FIG. 2 is a schematic diagram of a portion of an exemplary superconducting quantum processor 200, according to at least one implementation. Portion of superconducting quantum processor 200 may, in some implementations, form part of quantum processor 126 in computing system 100 as discussed above with respect to FIG. 1. Portion of superconducting quantum processor 200 shown in FIG. 2 includes two superconducting qubits 201, and 202. Also shown is a tunable coupling (diagonal coupling) via coupler 210 between qubits 201 and 202 (i.e., providing 2-local interaction). While the portion of quantum processor 200 shown in FIG. 2 includes only two qubits 201, 202 and one coupler 210, those of skill in the art will appreciate that quantum processor 200 may include any number of qubits and any number of couplers coupling information between them.

Quantum processor 200 includes a plurality of interfaces 221, 222, 223, 224, 225 that are used to configure and control the state of quantum processor 200. Each of interfaces 221-225 may be realized by a respective inductive coupling structure, as illustrated, as part of a programming subsystem and/or an evolution subsystem. Alternatively, or in addition, interfaces 221-225 may be realized by a galvanic coupling structure. In some implementations, one or more of interfaces 221-225 may be driven by one or more DACs. Such a programming subsystem and/or evolution subsystem may be separate from quantum processor 200, or may be included locally (i.e., on-chip with quantum processor 200). Control systems such as qubit control system 130, coupler control system 132, and readout control system 128 may communicate with quantum processor 200, as shown with respect to quantum processor 126 in FIG. 1.

In the operation of quantum processor 200, interfaces 221 and 224 may each be used to couple a flux signal into a respective compound Josephson junction 231 and 232 of qubits 201 and 202, thereby realizing a tunable tunneling term (the Δᵢ term) in the system Hamiltonian. This coupling provides the off-diagonal σ^{x} terms of the Hamiltonian and these flux signals are examples of “delocalization signals”. Examples of Hamiltonians (and their terms) used in quantum computing are described in greater detail in, for example, U.S. Patent Application Publication No. 2014/0344322.

Similarly, interfaces 222 and 223 may each be used to apply a flux signal into a respective qubit loop of qubits 201 and 202, thereby realizing the hᵢ terms (dimensionless local fields for the qubits) in the system Hamiltonian. This coupling provides the diagonal σ^{z} terms in the system Hamiltonian. Furthermore, interface 225 may be used to couple a flux signal into coupler 210, thereby realizing the Jᵢⱼ term(s) (dimensionless local fields for the couplers) in the system Hamiltonian. This coupling provides the diagonal σᵢ^{z} σⱼ^{z} terms in the system Hamiltonian.

While FIG. 2 illustrates only two physical qubits 201, 202, one coupler 210, and two readout devices 251, 252, a quantum processor (e.g., processor 126) may employ any number of qubits, couplers, and/or readout devices, including a larger number (e.g., hundreds, thousands or more) of qubits, couplers and/or readout devices. Examples of superconducting qubits include superconducting flux qubits, superconducting charge qubits, and the like. In a superconducting flux qubit, the Josephson energy dominates or is equal to the charging energy. In a charge qubit this is reversed. Examples of flux qubits that may be used include radio frequency superconducting quantum interference devices, which include a superconducting loop interrupted by one Josephson junction, persistent current qubits, which include a superconducting loop interrupted by three Josephson junctions, and the like.

### Random Number Generation Using a Quantum Processor

Random number generation is important in industries such as cryptography, where an unpredictable result is key to the security of the encryption. Random numbers may also be valuable in other security applications for this reason. Random number generators are typically implemented in software and generate pseudo random numbers, rather than truly random numbers. If random numbers are generated by an easily reproducible and/or predictable method, they are not particularly valuable for many applications (e.g., cryptography, wager-based gaming), as a third party may gain access by reproduction. Random numbers generated by quantum circuits may beneficially be both truly random numbers, in contrast to pseudo random numbers, and difficult to simulate classically due to the complexity of the quantum mechanics used in their generation. For this reason, it is beneficial to certify that the random numbers were generated by a quantum device, and are therefore inherently truly random, and not by a classical device, which would provide pseudo-random numbers. In order to verify the source of the numbers, there must be sufficient information known about the system that it is possible to perform verification, while also ensuring that the system is not easily simulatable and cannot be easily reproduced. A system and method of generating random numbers that may beneficially be verified as having been generated by a quantum processor is described herein.

FIG. 3 is a flow diagram of an example method 300 of operation of a computing system to generate random numbers, for example to generate truly random numbers. Method 300 may be executed on a hybrid computing system comprising at least one digital or classical processor and a quantum processor, for example digital processor 106 and quantum processor 126 of hybrid computing system 100 of FIG. 1. The quantum processor may be a quantum annealing processor or a gate model processor. The quantum processor may comprise an array of qubits, such as an array of superconducting qubits as discussed with respect to first qubit 201 and second qubit 202 of exemplary superconducting quantum processor 200 of FIG. 2. The quantum processor may also be a quantum processor that implements surface code, such as a gate model processor.

Method 300 comprises acts 302 to 312; however, a person skilled in the art will understand that the number of acts illustrated is an example, and, in some implementations, certain acts may be omitted, further acts may be added, and/or the order of the acts may be changed.

Method 300 starts, for example in response to a call or invocation from another routine or in response to an input by a user. Method 300 is performed by a processor in communication with a quantum processor, such as, for example, by classical processor 102 in communication with a quantum processor 126. Classical processor 102 can receive calls, invocations, or input as discussed above with respect to FIG. 1.

At 302, the processor, for example a classical or digital processor, may optionally provide an input value, or receive an input value. In some implementations, the input value can be a pseudo random number generated by a separate classical processor, or a pseudo random number generated by the first processor as part of method 300. In other implementations, the input value can be provided to the first processor by a user or as the result of another method. The input value can, for example, specify or represent one or more modifications to one or more parameters of a Hamiltonian.

At 304, the processor, for example a classical or digital processor, defines a Hamiltonian having a highly entangled nontrivial ground state. The highly entangled nontrivial ground state will have a uniform distribution of classical ground states. This refers to a system with a ground state that is a superposition of an exponentially large number of classical states, and is not separable. Quantum systems having highly entangled nontrivial ground states include quantum spin liquids and quantum spin ices. Examples of these quantum systems are discussed, for example, in King et al., Qubit spin ice, arXiv:2007.10555v2 [quant-ph], 16 Jul. 2021, Chamon and Green, A superconducting circuit realization of combinatorial gauge symmetry, arXiv:2006.10060v1 [quant-ph], 17 Jun. 2020, and Zhou et al., Experimental Realization of Spin Liquids in a Programmable Quantum Device, arXiv:2009.07853v2 [cond-mat.str-el], 29 Sep. 2020.

At 306, the processor, for example a classical or digital processor, introduces one or more distortions to the Hamiltonian by one or more random variations based on the input value(s) to provide a modified Hamiltonian. Providing an input value that defines the distortions introduced to the Hamiltonian can beneficially allow for the creation of a system that is distinguishable from the system of the unmodified Hamiltonian in a manner that is controlled and with known distortions. These random variations defined by the input value can include one or more of: random coupling values, random biases on the qubits, or randomly located defects in the quantum system. The distortion introduced by these random variations can be selected to be sufficiently large that the resulting distribution is distinguishable from a uniform distribution, and therefore can be certified. Certification in this context refers to verifying the authenticity of the generated random numbers as being randomly generated by a quantum processor, and is discussed below with respect to method 400. The distortion must also be sufficiently small that the distribution may not be easily simulated, as the introduction of too much distortion will cause the ground state of the system to lose its highly entangled state and become less complex. The number or magnitude of the distortions that fall within this range can be determined by a process similar to the certification process described below with respect to method 400. The amount of distortion can also be determined by providing two different inputs to the system, and determining if the resulting distributions are distinguishable. In implementations where the superconducting qubits are communicatively coupled in a 2D lattice, the one or more random variations can be introduced with randomly located holes in the 2D lattice. In a quantum spin liquid, a hole refers to a parity coupler that is turned OFF or otherwise altered to not act as a parity coupler. This distortion can also include qubits or couplers that are deactivated. At 308, the processor, for example a classical or digital processor, instructs the quantum processor to selectively communicatively couple the superconducting qubits to embed a quantum system defined by the modified Hamiltonian. As discussed below, in some implementations, the superconducting qubits can be communicatively coupled in a 2D lattice.

At 310, the processor, for example a classical or digital processor, causes the quantum processor to evolve over the embedded quantum system based on the input value. In some implementations, the quantum processor can evolve through a quantum annealing process. In other implementations the evolution can be over a surface code implementation. Measuring the resulting ground state provides a random sample from a thermodynamically large number of states. The set of samples from the quantum processors provides a set of random numbers.

At 312, the processor, for example a classical or digital processor, receives a set of random numbers from the quantum processor as a set of samples.

After 312, method 300 terminates, until it is, for example, invoked again. The random numbers received at act 312 can be passed to other algorithms, or be used in other acts such as being input into certification method 400, or to encrypt data securely as part of an encryption algorithm.

In some implementations, the method can continue with additional input values to generate further random numbers. For example, a second input value can be provided to the quantum processor, the Hamiltonian can again be modified based on the second input value, and the quantum processor can be caused to evolve over the embedded quantum system based on the second input value. A second set of random numbers can then be received from the quantum processor.

In some implementations, it may be beneficial to certify if the numbers were generated by a quantum device, as opposed to a classical device, in order to show that they were produced by a method that cannot easily be predicted or reproduced and/or that the generated numbers are truly random and not just pseudo random. The authenticity of the random numbers may be verified, for example, by introducing the random numbers into a classical simulation of the quantum circuit in order to assign probabilities to the states generated by the quantum circuit. Calculation of the cross-entropy between the samples allows for comparison to a threshold selected to assure that no classical circuit could have generated the set of random numbers within a given timeframe.

FIG. 4 is a flow diagram of an example method 400 to verify random numbers and to provide certification that the random numbers were generated using a quantum processor. Method 400 may be executed by a classical processor in response to receiving random numbers, such as a subset of the set of random numbers received from a quantum processor in act 312 of method 300. A subset of the generated set of random numbers may be selected at any time for verification and certification.

To be useful, the random numbers are generated by the quantum processor with sufficient complexity that the random numbers cannot be simulated by a classical processor within a comparable timeframe. For example, a quantum processor may provide a random number every couple of seconds, while the certification process for a small subset of those numbers may take hours or days. If the random numbers were generated as entirely uncoupled quantum random numbers, the random numbers would be impossible to verify classically. In a quantum spin liquid, the qubits have highly complex but known correlations. The provided input provides known, but pseudo random, distortions to the quantum spin liquid, allowing the random numbers generated to be unique, but in such a way that they can be simulated, at a much longer time scale than they were generated. Because the input Hamiltonian is known it provides a distinct, distinguishable, but highly complex distribution that can be simulated to perform verification and to provide certification.

Method 400 comprises acts 402 to 408; however, a person skilled in the art will understand that the number of acts illustrated is an example, and, in some implementations, certain acts may be omitted, further acts may be added, and/or the order of the acts may be changed.

Method 400 starts, for example in response to a call or invocation from another routine or in response to an input by a user. In some implementations, method 400 starts in response to receiving a subset of the set of random numbers generated by method 300.

At 402, the processor inputs the subset of numbers to be certified, such as the subset of the set of one or more random numbers generated by method 300, into a classical simulation of the quantum circuit. In some implementations, the processor may be part of a hybrid computing system, such as classical computer 102 of computing system 100 discussed with respect to FIG. 1, or the processor may be a separate classical processor that receives samples from the classical processor discussed with respect to method 300. In some implementations, the subset of the set of one or more random numbers may be input into a quantum Monte Carlo (QMC) simulation. This may include clamping the state of one of the Trotter layers to a state given by the subset and allowing the system to equilibrate. The ratio of the partition function of the equilibrated system and the free system provides the probability of the state given by the subset. This may be used to calculate the probability of each random number in the subset of random numbers generated by the quantum processor. It will be understood that other classical simulations providing the probability of the distribution of the subset may also be used.

At 404, the processor calculates a cross-entropy for the subset of numbers, that is, the cross-entropy for the distribution of samples in the subset of random numbers, based on probabilities assigned to the subset of numbers from the classical simulation of the quantum circuit. In some implementations, in response to receiving a probability assigned to each of the numbers of the subset, the processor may calculate the log likelihood of each of the numbers. Given the probability of every sample in the subset, the log likelihood of the sample can be calculated.

With respect to calculating the cross-entropy as discussed with respect to act 404, if the subset of samples from the quantum processor returns K samples Sᵢ, each having expected probability pᵢ calculated using QMC, the cross-entropy of the samples may be given by:

$${S}_{QPU} = - {\sum }_{i} {p}_{i}^{QPU} log {p}_{i} = - \frac{1}{K} {\sum }_{i = 1}^{K} log {p}_{i} .$$

This value may be compared to what would be obtained if K samples were randomly chosen from the classical ground state subspace given by:

$${S}_{random} = - {\sum }_{i} {p}_{i}^{random} log {p}_{i}$$

Fidelity may be defined by:

$$F = \frac{{S}_{random} - {S}_{QPU}}{{S}_{random} - S}$$

$$Where$$

$$S = - {\sum }_{i} {p}_{i} log {p}_{i}$$

Is the entropy that can be estimated using the QMC simulation.

At 406, the processor compares the cross-entropy to a threshold.

At 408, in response to finding that the magnitude of the cross-entropy for the subset is higher than the threshold, the processor returns a certification of the set of random numbers as authentic, that is, the processor verifies that the set of random numbers was generated by a quantum processor, and are therefore inherently truly random.

With respect to the threshold discussed with respect to act 406, F=0 would indicate uniform random generation of the samples, while F=1 would indicate that the samples are coming from an ideal quantum device. If the fidelity is larger than a threshold, the samples may be considered acceptable, that is, that they are sufficiently randomly generated for use in a given application. In other words, the samples generated have been shown to be generated by something close to an ideal quantum device. The threshold should be selected to be large enough to eliminate the possibility of the samples being generated by approximate fast classical algorithms, but small enough to allow for calibration and other types of errors in the quantum device. It will be understood that the use of the term threshold may be either inclusive or exclusive depending on the application.

In other words, for F=0, no information would be provided by the returned samples about the input, the distribution of the subset would be entirely a uniform random distribution that would be indistinguishable from the distribution that would be generated from a different input. F=1 would indicate that the samples come from a quantum device having no noise or decoherence, which would be difficult or impossible to simulate classically. A classical simulation of a quantum circuit would typically have F>0, but smaller than the F for a quantum processor. However, for any physical quantum processor, F<1 will occur due to the impacts of noise, control error, decoherence, etc. Therefore, the threshold value of F will be selected to be less than the F of the quantum processor, and greater than the F for a classical processor. This will generally be determined for individual processors based on properties of the processor. Selecting a value of F that is too high may fail as the quantum hardware may not reach it, however, selecting a value of F that is too low may also fail as a classical processor may easily achieve the threshold.

The threshold may, in an example implementation, be determined by finding the average fidelity of quantum hardware samples for a set of random inputs, and then setting the threshold slightly below the average fidelity. For example, the threshold may be set such that the quantum hardware passes the threshold with a high (e.g., 95%) probability. The threshold is selected such that in order for a classical simulator (e.g., quantum Monte Carlo) to generate samples that would pass the threshold the computation time would be several orders of magnitude longer than required by the quantum processor.

Similarly, the level of distortion applied to the quantum system may also be determined empirically based on the fidelity of the hardware samples. As discussed above, the possible fidelity for a given quantum processor may first be determined, for example by taking samples from the processor without any distortions and based on random inputs. The fidelity of a given quantum processor will not be perfect, that is, will not be 1, as inherent flaws in the system due to noise, control errors, fabrication variations, etc., will result in a quantum system that is not 100% perfect. Once it is known what fidelity is achievable for a given quantum processor without distortions, the amount of distortion applied to the system may be varied to find an optimal or near optimal amount of distortion. The selected amount of distortion will beneficially be one that provides a high fidelity (e.g., close to the fidelity determined for the processor) with the chosen pseudo-random input, and a distinguishably lower fidelity when the fidelity is determined based on a pseudo-random input that was not used to generate the samples. That is, the fidelity should be distinguishable between the pseudo-random input used and a different pseudo-random input.

In an example implementation, a pseudorandom input is provided to the Hamiltonian embedded on the quantum processor, as discussed above. Several samples (e.g., 1000) are generated, and the fidelity of these samples can be determined based on probabilities calculated using QMC with the same input (i.e., the same pseudorandom number). The fidelity can also be calculated for the same samples, but with the probabilities being calculated using a different pseudorandom input. If the distortion selected is too small, the two calculated fidelities will be very similar. If the distortion is too strong, the fidelities will be very different, but both low, meaning that a classical simulation could more easily generate samples with the same fidelity.

After 408, method 400 terminates, until it is, for example, invoked again.

A computing system, such as computing system 100 of FIG. 1, may be used in random number generation. As discussed above, a computing system may have a first processor and a second processor, with the first processor in communication with the second processor. The computing system may include at least one non-transitory processor-readable medium that stores at least one of processor executable instructions and data, the second processor communicatively coupled to the at least one non-transitory processor-readable medium. The first processor may be a quantum processor such as quantum processor 126 above, and the second processor may be a classical processor, such as digital processor 106 above. A quantum processor may have superconducting qubits that are selectively communicatively couplable by a plurality of couplers, as shown, for example, in FIG. 2, with qubits 201 and 202 selectively communicatively couplable by coupler 210. A quantum processor may take other forms, such as a non-superconducting processor, a gate model processor, etc. One implementation of a superconducting quantum processor is described below; however, it will be understood that similar principles may be applied to other types of processors.

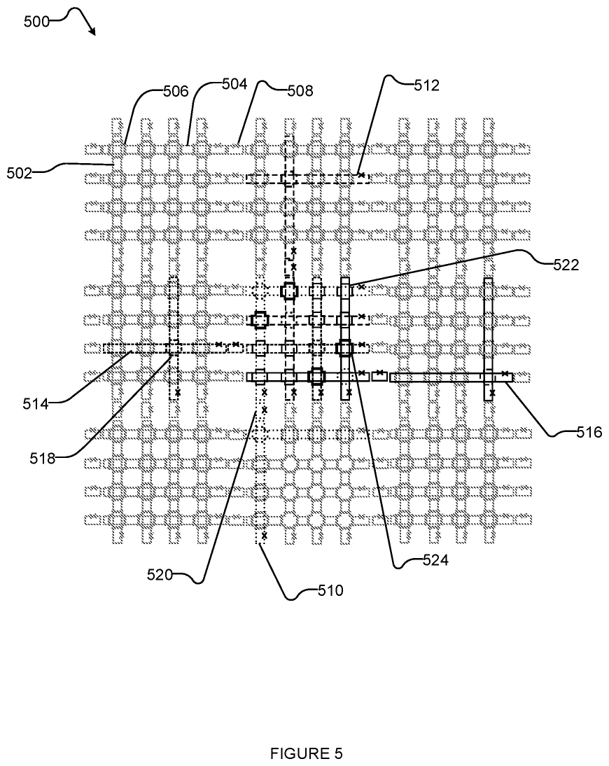

Referring to FIG. 5, an example quantum processor 500 having an array of superconducting qubits 502, 504 selectively communicatively couplable by a plurality of couplers 506, 508 is shown (only one of each called out to avoid clutter). In the example implementation of FIG. 5, qubits 502 and 504 are oriented orthogonally to each other. Couplers 506 are internal couplers that provide a selective communicative coupling between orthogonal qubits 502 and 504 within a tile of quantum processor 500. Couplers 508 are external couplers that provide a selective communicative coupling between qubits in different tiles of quantum processor 500. In the example implementations of FIGS. 2 and 5, the couplers provide inductive coupling between qubits. It will be understood that the arrangement of FIG. 5 is an example topology of qubits and couplers, and that other topologies may be used. Descriptions of example alternative topologies can be found in U.S. Pat. Nos. 7,533,068 and 8,421,053; U.S. Patent Application Publication No. 2019/0220771; and U.S. Provisional Patent Application No. 63/227,395.

In response to execution of the at least one of processor executable instructions and data, the second processor instructs the quantum processor to selectively communicatively couple the superconducting qubits to embed a quantum system having a highly entangled nontrivial ground state, the highly entangled nontrivial ground state comprising a uniform superposition of classical ground states. This may, for example, include a 2-dimensional lattice such as a quantum spin liquid or a quantum spin ice. Detailed discussions of these quantum systems can be found in, for example, in King et al., Qubit spin ice, arXiv:2007.10555v2 [quant-ph], 16 Jul. 2021, Chamon and Green, A superconducting circuit realization of combinatorial gauge symmetry, arXiv:2006.10060v1 [quant-ph], 17 Jun. 2020, and Zhou et al., Experimental Realization of Spin Liquids in a Programmable Quantum Device, arXiv:2009.07853v2 [cond-mat.str-el], 29 Sep. 2020. Referring to FIG. 5, an example plaquette forming part of the embedding of a quantum spin ice, as described in King et al., Qubit spin ice, arXiv:2007.10555v2 [quant-ph], 16 Jul. 2021, is shown. The example embedding has a first chain of qubits and couplers 510 represented by bold dotted lines. The embedding has a second chain 512 represented by long dashed lines, a third chain 514 represented by short, dashed lines, and a fourth chain 516 represented by solid lines. The intra-chain internal couplers such as coupler 518 (only one called out to reduce clutter) are represented by dashed lines, while the intra-chain external couplers such as coupler 520 (only one called out to reduce clutter) are represented in the same pattern as their respective chain. In the center tile, two types of inter-chain internal couplers are shown. Perpendicular inter-chain couplers 522 (only one called out to reduce clutter) are shown in solid lines, while parallel inter-chain couplers 524 (only one called out to reduce clutter) are shown in bold solid lines. Further detail on this embedding is provided in King et al. as referenced above.

A quantum system, such as the example system of FIG. 5, is also provided with one or more distortions based on an input value by one or more random variations. The input value may, in some implementations, be a pseudo random number generated by a classical processor, provided by a user, or generated by the second processor, as discussed above. These distortions may include one or more random coupling values being introduced to one or more couplers of the plurality of couplers, such as by applying a random signal to coupler 518, for example. This may be performed through control lines or structures, such as interface 225 of FIG. 2. These distortions may also include random biases applied to one or more qubits, such as qubit 514. In some implementations, one or more bias lines, such as interfaces 221, 222, 223, and 224 of FIG. 2, may be provided with one or more random bias signals that provide a random bias to one or more qubits to distort the uniform distribution. These distortions may also include introducing randomly located defects or holes in a quantum spin ice system, by, for example, deactivating one or more couplers or qubits to form a hole or holes in an embedded lattice. Deactivation may be performed by preventing communication between the qubit or coupler and surrounding devices, such as by applying signals through control lines or control structures. In some implementations, the second processor provides a signal through a control line or to a control structure that produces one or more randomly located defects in the quantum system.

The second processor causes the quantum processor to evolve over the embedded quantum system with the induced distortions based on the input value. The randomly introduced distortions will cause random variation in the uniform distribution of ground states, allowing for the resulting sample or samples to be randomly generated but simulatable for verification. The second processor then receives a set of one or more random numbers from the quantum processor.

It may be beneficial to increase the gap size, that is, the energy spacing between the ground state and the first excited state, to increase the probability of remaining in the ground state. While in some implementations the methods described herein may work at finite temperatures, such as for complex systems with large numbers of qubits, generally at higher temperatures the quantum system becomes easier to simulate. Therefore, the requirements for a sufficiently complex quantum processor may be lower if it remains in the ground state. In some implementations, the gap size may beneficially be increased by including one or more parity enforcing couplers. For example, one or more couplers may be introduced that operate as 4-qubit parity enforcing couplers. The type of parity enforcing coupler, that is, how many qubits it enforces parity for, will depend on the type of spin liquid defined. For example, in surface code implementations, a variety of different parity enforcing couplers may be present. Introducing one or more parity enforcing couplers may increase the number of potential ground states available to the system, thereby increasing the coherence of the system, or decreasing the impact of noise. The system is beneficially in the coherent regime for the quantum evolution discussed above to reduce the impact of the environment on the generated samples. A parity enforcing coupler is any coupler that is coupled such that the overall energy state of the system has two levels: a first level when all of the connected qubits have an even number of qubits in a given state, and a second level when all of the connected qubits have an odd number of qubits in a given state. See International Application No. PCT/US2021/024134 for a further discussion of parity stabilizers.

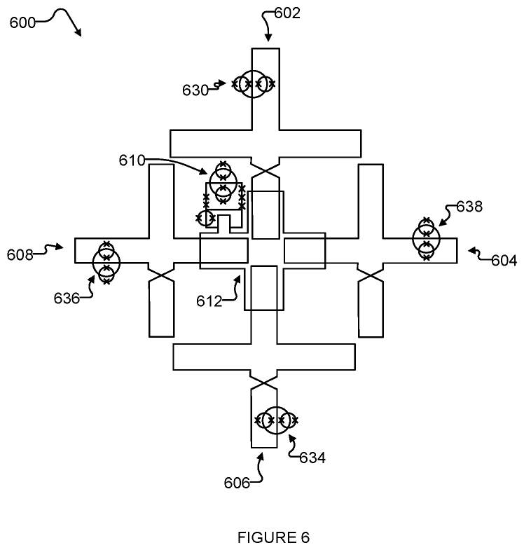

FIG. 6 is a schematic diagram of an example implementation of a circuit 600 including a 4-qubit stabilizer as discussed in International Application No. PCT/US2021/024134, and which may be used to provide 4-qubit parity enforcing coupling. In circuit 600, four physical qubits 602, 604, 606, and 608, and an auxiliary qubit 610 are communicatively coupled by a single linear coupling device 612. Each physical qubit 602, 604, 606, and 608 has a compound-compound Josephson junction (CCJJ) 630, 632, 634, and 636, respectively. As used herein, compound-compound Josephson junction refers to a Josephson junction where one or more of the junctions within a compound Josephson junction is itself a compound Josephson junction. It will be understood that FIG. 6 provides an example implementation of a parity enforcing coupler, and other coupling arrangements as are known in the art may be used.

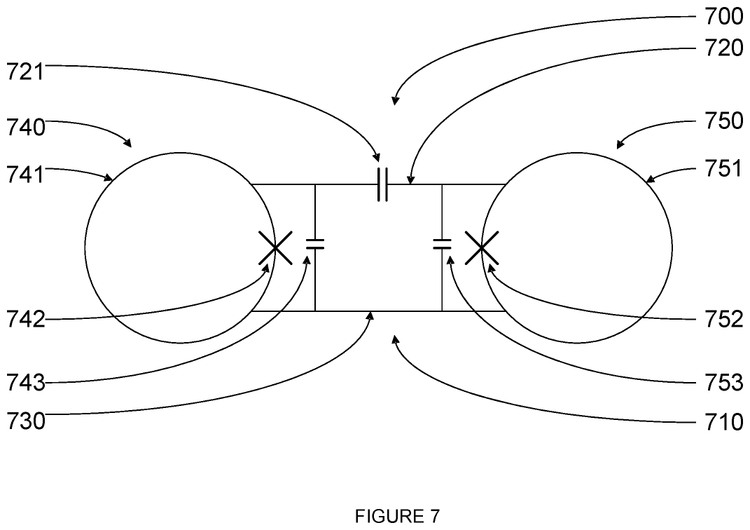

The gap size may also beneficially be increased by adding charge coupling between qubits. For example, in the circuit proposed by Chamon et al., referenced above, adding charge couplers (also referred to as capacitive couplers) between one or more of the gauge qubits in the circuit may increase the gap size. Charge coupling increases the gap size as it increases the available tunneling to the system. Referring to FIG. 7, a system 700 that has a capacitive coupler 710 capable of coupling between a first qubit 740 and a second qubit 750 is shown. First qubit 740 may be comprised of a loop of superconducting material 741 interrupted by a Josephson junction 742 having an intrinsic capacitance graphically represented by capacitor symbol 743. Second qubit 750 may be comprised of a loop of superconducting material 751 interrupted by a Josephson junction 752 having an intrinsic capacitance graphically represented by a capacitor symbol 753. First qubit 740 and second qubit 750 are connected by conductive paths 720 and 730. The conductive paths 720, 730 may, for example, take the form of one or more wires or traces of material that is superconducting below a critical temperature, to form superconductive paths. Superconducting path 720 is interrupted by a coupling capacitor 721. Other example embodiments of couplers providing capacitive (or charge) coupling can be found in U.S. Pat. No. 8,102,185 and International Publication No. WO 2020/210536.

The systems and methods described herein may beneficially allow for the generation of truly random numbers that are certifiable. The described techniques may beneficially provide a balance between generating random numbers that are difficult to simulate classically and numbers that are still possible to simulate for certification. In order for this to be useful, the quantum processor may rapidly generate random numbers, and a small subset of those random numbers may be certified through classical simulation over a longer time scale. It is beneficial to use a quantum system such as a quantum spin liquid having highly complex correlations. See King et al., Qubit spin ice, arXiv:2007.10555v2 [quant-ph], 16 Jul. 2021, Chamon and Green, A superconducting circuit realization of combinatorial gauge symmetry, arXiv:2006.10060v1 [quant-ph], 17 Jun. 2020, and Zhou et al., Experimental Realization of Spin Liquids in a Programmable Quantum Device, arXiv:2009.07853v2 [cond-mat.str-el], 29 Sep. 2020, for further discussions of the features of quantum spin liquids. While an uncoupled quantum processor may generate random numbers, the resulting numbers would be unentangled and would be impossible to simulate, and therefore impossible to certify. The use of a system with highly complex correlations may beneficially allow for simulation. However, if a known and unmodified system is used for generation of random numbers, it may be possible to create a classical simulation of the complex correlations. Therefore, it is beneficial to modify the distribution for random number generation. Random distortions are added to make a distinct distribution that cannot be known by a third party and is not easily simulatable. By starting from a pseudo random but known input as a way to introduce random distortions to a quantum Hamiltonian, the system can beneficially move away from ideal randomness in a way that cannot be reproduced by a third party. It will be understood that the random numbers may, for example, be strings of digits of varying lengths as required by a given application. The random numbers may, in some implementations, be used as cryptographic keys to transmit data securely, or for other security applications.

A quantum processor must be sufficiently complex as to be difficult to simulate using a classical processor, but not impossible. For example, in some implementations, a quantum processor may have 5000 qubits and produce a random number every few seconds, while verifying and certifying a small subset of those random numbers, for example, a subset of 1000 numbers, may take hours, a day, or longer. A pseudo random number may be generated and provided as input, allowing a user to generate random numbers from a distribution that cannot be known by a third party, but with a distortion that is known and has been controlled by the user and is therefore simulatable. Distortions applied are beneficially sufficiently large as to be distinguishable from other distributions, but not so large that the ground state becomes less complex. For example, if the distortions applied are bias values, if too many bias values are applied to qubits the system simply aligns with the bias values and becomes trivial. It is beneficial to apply only enough biases to qubits as to make the resulting distribution distinguishable from the original Hamiltonian's distribution.

In one example implementation, the method may be performed by a classical processor in communication with a quantum processor. The quantum processor may be a quantum annealing processor having a plurality of qubits communicatively coupled by couplers, such as a processor having a plurality of superconducting qubits (e.g., >5000) and couplers (e.g., >35,000). A pseudorandom number may be provided as input, and may be generated by the classical processor or provided by a separate pseudorandom number generator or a user. For example, the pseudorandom number may be a string of 500 digits, with each digit being used to define the magnitude and/or location of a distortion. The classical processor defines a quantum spin liquid in the form of a Hamiltonian, and the pseudorandom number is used to introduce distortions to the quantum spin liquid. The distortions may, for example, be defined by 10% of the couplers receiving a random offset to the coupling value, 10% of the qubits receiving a random offset to the applied bias value, or 10% of the parity enforcing couplers being deactivated to provide randomly located holes in the lattice, with the locations and/or magnitudes of these distortions being determined by the input value. The classical processor provides instructions to the quantum processor to embed this modified system, and the quantum processor is then caused to evolve, by quantum annealing, over the embedded quantum system, to achieve a ground state.

In the ground state of the quantum processor the state of each qubit is measured and projected into the computation bases as a bit string of 0's and 1's based on the qubit state. Each qubit returns a random number (that is, a bit). The quantum correlation that exists between these qubits can be detected by the certification process as discussed above. For the example of the 5000 qubit processor, the result of a single anneal will return a bit string of 5000 0's and 1's as a random number that may, for example, be used to encrypt some data. In order to generate 1000 random numbers, the quantum processor may be annealed 1000 times. In other implementations, the bit string may be used in portions. For example, the string of 5000 0's and 1's may be split equally into 5 parts to return 5 random numbers each having 1000 bits.

Quantum annealing may be repeated thousands of times for a given modified Hamiltonian, thereby providing a set of random numbers from the quantum processor made up of thousands of random numbers. Generating the thousands of random numbers may only take the quantum processor a few seconds, as each anneal may take on the order of microseconds. A classical simulation of the quantum system may take minutes or hours to return random numbers. A subset of random numbers from the thousands of random numbers, for example, a subset of 1000 measurements of all qubits, or 1000 bit strings, may be selected from the set of random numbers, and input into a classical simulation of the quantum system. The distribution that would generate these random numbers may be simulated, and based on the cross-entropy for the subset of numbers, it may be confirmed that the subset of numbers was generated by a quantum system rather than a classical system, meaning that that the generated numbers are truly random.

The above-described method(s), process(es), or technique(s) could be implemented by a series of processor readable instructions stored on one or more nontransitory processor-readable media. Some examples of the above-described method(s), process(es), or technique(s) method are performed in part by a specialized device such as an adiabatic quantum computer or a quantum annealer or a system to program or otherwise control operation of an adiabatic quantum computer or a quantum annealer, for instance a computer that includes at least one digital processor. The above-described method(s), process(es), or technique(s) may include various acts, though those of skill in the art will appreciate that in alternative examples certain acts may be omitted and/or additional acts may be added. Those of skill in the art will appreciate that the illustrated order of the acts is shown for exemplary purposes only and may change in alternative examples. Some of the exemplary acts or operations of the above-described method(s), process(es), or technique(s) are performed iteratively. Some acts of the above-described method(s), process(es), or technique(s) can be performed during each iteration, after a plurality of iterations, or at the end of all the iterations.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other methods of quantum computation, not necessarily the exemplary methods for quantum computation generally described above.

The various implementations described above can be combined to provide further implementations. All of the commonly assigned US patent application publications, US patent applications, foreign patents, and foreign patent applications referred to in this specification and/or listed in the Application Data Sheet are incorporated herein by reference, in their entirety, including but not limited to:
U.S. Pat. Nos. 7,533,068; 8,008,942; 8,102,185; 8,195,596; 8,190,548; and 8,421,053.
U.S. Patent Application Publication Nos. 2014/0344322; and 2019/0220771.
U.S. Provisional Patent Application Nos. 63/227,395 and 63/313,451.
International Publication No. WO 2020/210536.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method of generating random numbers, the method performed by a first processor in communication with a quantum processor, the quantum processor comprising a plurality of qubits, the method comprising:
defining a Hamiltonian having a highly entangled nontrivial ground state, the highly entangled nontrivial ground state comprising a uniform superposition of classical ground states;
introducing one or more distortions to the Hamiltonian by one or more random variations, the one or more random variations selected based on an input value to provide a modified Hamiltonian;
instructing the quantum processor to selectively communicatively couple the plurality of qubits to embed a quantum system defined by the modified Hamiltonian;
causing the quantum processor to evolve over the embedded quantum system; and
receiving a set of random numbers from the quantum processor.

2. The method of claim 1, wherein introducing one or more distortions to the Hamiltonian by one or more random variations comprises introducing one or more of random coupling values, random biases on one or more qubits of the plurality of qubits, or randomly located defects in the quantum system.

3. The method of claim 1, further comprising providing a first input value by the first processor, wherein providing an input value comprises generating a pseudo random number as the input value.

4. The method of claim 1, wherein defining a Hamiltonian comprises defining the Hamiltonian of a quantum spin liquid.

5. The method of claim 1, wherein instructing the quantum processor to selectively communicatively couple the plurality of qubits comprises instructing the quantum processor to selectively communicatively couple the plurality of qubits in a 2D lattice.

6. The method of claim 5, wherein introducing one or more distortions to the Hamiltonian by one or more random variations comprises introducing randomly located holes in the 2D lattice.

7. The method of claim 1, further comprising:
introducing one or more distortions to the Hamiltonian by one or more random variations based on a second input value to provide a second modified Hamiltonian;
causing the quantum processor to evolve over the second modified Hamiltonian; and
receiving a second set of random numbers from the quantum processor.

8. The method of claim 1, further comprising:
inputting a subset of numbers from the set of random numbers into a classical simulation of the quantum system;
calculating a cross-entropy for the subset of numbers based on probabilities assigned to the subset of numbers from the classical simulation of the quantum system;
comparing the cross-entropy to a threshold; and
in response to a magnitude of the cross-entropy being greater than the threshold, returning a certification of the set of random numbers as authentic.

9. The method of claim 8, wherein inputting a subset of numbers from the set of random numbers into a classical simulation of the quantum system comprises inputting the subset of numbers into a quantum Monte Carlo simulation.

10. The method of claim 8, wherein calculating a cross-entropy for the subset of numbers based on probabilities assigned to the subset of numbers from the classical simulation of the quantum system comprises calculating a cross-entropy for the subset of numbers based on probabilities assigned to each of the numbers of the subset of numbers and a log likelihood of each number of the subset of numbers.

11. The method of claim 1, wherein instructing the quantum processor to evolve over the embedded quantum system comprises instructing the quantum processor to perform a quantum annealing evolution.

12. A computing system for use in random number generation, the computing system comprising:
a first processor and a second processor, the first processor in communication with the second processor, the first processor comprising a quantum processor comprising a plurality of qubits selectively communicatively couplable by a plurality of couplers; and
at least one non-transitory processor-readable medium that stores at least one of processor executable instructions and data, the second processor communicatively coupled to the at least one non-transitory processor-readable medium, the second processor, in response to execution of the at least one of processor executable instructions and data:
defines a Hamiltonian having a highly entangled nontrivial ground state, the highly entangled nontrivial ground state comprising a uniform superposition of classical ground states;
defines one or more distortions to the Hamiltonian by one or more random variations, the one or more random variations selected based on the input value to provide a modified Hamiltonian;
instructs the quantum processor to selectively communicatively couple the plurality of qubits to embed a quantum system defined by the modified Hamiltonian;
causes the quantum processor to evolve over the embedded quantum system; and
receive a set of random numbers from the quantum processor.

13. The computing system of claim 12, wherein the plurality of qubits comprises a plurality of superconducting qubits.

14. The computing system of claim 12, wherein the input value comprises a pseudorandom number provided by the second processor.

15. The computing system of claim 12, wherein the input value defines one or more random coupling values to one or more couplers of the plurality of couplers to introduce the one or more distortions.

16. The computing system of claim 12, further comprising one or more bias lines communicatively coupled to the plurality of qubits, and wherein the input value defines one or more random biases to the one or more bias lines to introduce the one or more distortions.

17. The computing system of claim 12, wherein the input value defines one or more randomly located defects to introduce the one or more distortions.

18. The computing system of claim 12, wherein the input value comprises a pseudo random number generated by a classical processor.

19. The computing system of claim 12, wherein the embedded quantum system comprises a quantum spin liquid.

20. The computing system of claim 12, wherein the embedded quantum system comprises a 2D lattice.

21. The computing system of claim 20, wherein the input value defines randomly located holes in the 2D lattice to introduce the one or more distortions.

22. The computing system of claim 12, wherein at least one coupler of the plurality of couplers comprises a parity coupler.

23. The computing system of claim 12, wherein at least one coupler of the plurality of couplers comprises a capacitive coupler.

24. The computing system of claim 12, wherein at least one coupler of the plurality of couplers comprises an inductive coupler.

25. The computing system of claim 12, wherein the quantum processor comprises a quantum annealing processor.
